(19) United States
(12) Patent Application Publication
(10) Pub. No.: US 2017/0232982 A1
(43) Pub. Date: Aug. 17, 2017

(54) ABNORMALITY DIAGNOSIS APPARATUS, ABNORMALITY DIAGNOSIS METHOD, AND NON-TRANSITORY COMPUTER READABLE MEDIUM

(71) Applicant: KABUSHIKI KAISHA TOSHIBA, Tokyo (JP)

(72) Inventor: Akihiro ITAKURA, Kawasaki (JP)

(21) Appl. No.: 15/266,391

(22) Filed: Sep. 15, 2016

(30) Foreign Application Priority Data
Feb. 15, 2016 (JP) 2016-025972

(51) Int. Cl. B61K 9/00; B61L 25/04; B61L 25/02; G07C 5/08; B61L 27/04

(52) U.S. Cl. CPC B61K 9/00; G07C 5/0808; B61L 27/04; B61L 25/021; B61L 25/025; B61L 25/04

(57) ABSTRACT

According to one embodiment, an abnormality diagnosis apparatus includes processing circuitry. The processing circuitry estimates a reduction amount of a regeneration amount of a diagnosed vehicle that is a railway vehicle, based on vehicle data of the diagnosed vehicle and vehicle data of a peripheral vehicle different from the diagnosed vehicle. The processing circuitry corrects the regeneration amount of the diagnosed vehicle, based on the estimated reduction amount. The processing circuitry diagnoses abnormality of a regenerative brake of the diagnosed vehicle, based on the corrected regeneration amount.

### CROSS-REFERENCE TO RELATED APPLICATIONS

This application is based upon and claims the benefit of priority from Japanese Patent Application No. 2016-025972, filed Feb. 15, 2016; the entire contents of which are incorporated herein by reference.

### FIELD

Embodiments described herein relates to an abnormality diagnosis apparatus, an abnormality diagnosis method, and a non-transitory computer readable medium.

### BACKGROUND

A driver of a railway vehicle operates a brake handle provided on a control platform to stop the vehicle at a target position. If the brake is not normally operated, the railway vehicle may not stop at the target position to impair convenience of passengers, or may not perform urgent stop to cause an accident. Thus, to perform safe operation of the railway vehicle, maintenance and management of the brake are important.

In the past, the maintenance and the management of the railway vehicle are performed mainly through periodic inspection. In contrast, in recent years, a system that collects data of an operating vehicle to monitor the state of the railway vehicle is under consideration in order to find abnormality of the railway vehicle in an early stage.

As such a system, a system has been proposed in which a sensor is attached to an axle and a wheel of the railway vehicle to acquire data in traveling and in stopping, and the acquired data and a reference value are compared with each other to diagnose abnormality of the railway vehicle. It is, however, difficult for the system to diagnose abnormality of the regenerative brake provided in the railway vehicle. The reasons are as follows.

In the regenerative brake, it is premised that energy regenerated by a certain railway vehicle is used by other railway vehicle. Thus, the regenerative brake includes a function of forcibly suppressing the brake function when the energy is difficult to be used by the other railway vehicle, namely, regeneration reduction function. In other words, performance of the regenerative brake of the certain railway vehicle is influenced by an external factor of the other railway vehicle. As a result, even when abnormality of the regenerative brake of the certain railway vehicle is diagnosed based on only data of the railway vehicle, as with the above-described existing system, high diagnosis accuracy is not obtainable.

### BRIEF DESCRIPTION OF THE DRAWINGS

FIG. 1 is a diagram illustrating an example of an abnormality diagnosis system;

FIG. 2 is a diagram illustrating an example of a vehicle DB;

FIG. 3 is a diagram illustrating an example of a hardware configuration of an abnormality diagnosis apparatus;

FIG. 4 is a flowchart illustrating operation of the abnormality diagnosis apparatus;

FIG. 5 is a diagram for explaining a method of extracting vehicle data; and

FIG. 6 is a diagram illustrating an example of a route chart.

### DETAILED DESCRIPTION

According to one embodiment, an abnormality diagnosis apparatus includes processing circuitry. The processing circuitry estimates a reduction amount of a regeneration amount of a diagnosed vehicle that is a railway vehicle, based on vehicle data of the diagnosed vehicle and vehicle data of a peripheral vehicle different from the diagnosed vehicle. The processing circuitry corrects the regeneration amount of the diagnosed vehicle, based on the estimated reduction amount. The processing circuitry diagnoses abnormality of a regenerative brake of the diagnosed vehicle, based on the corrected regeneration amount.

Hereinafter, some embodiments of the present invention are described with reference to drawings.

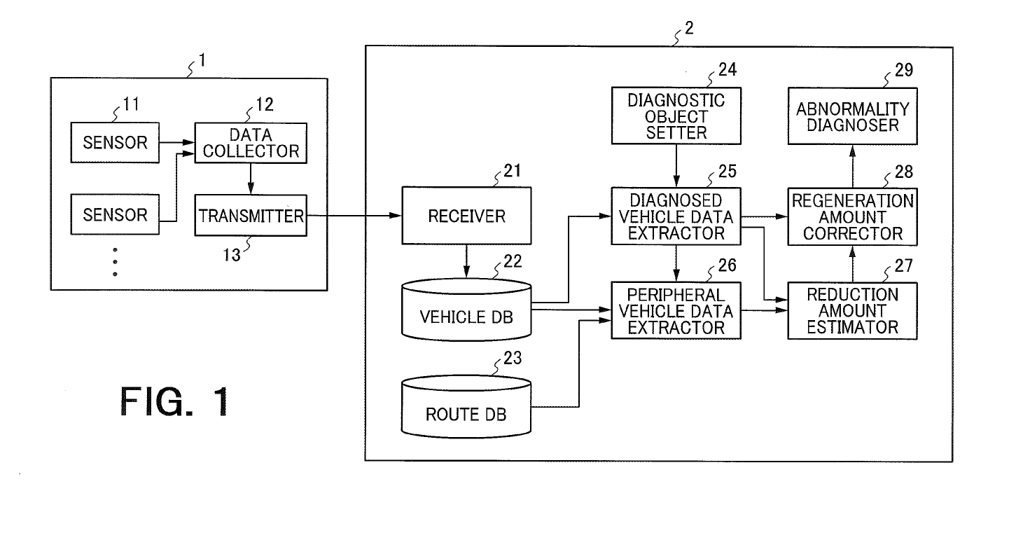

An abnormality diagnosis system of a railway vehicle according to an embodiment is described with reference to FIG. 1 to FIG. 6. FIG. 1 is a diagram illustrating an example of the abnormality diagnosis system according to the present embodiment. The abnormality diagnosis system of FIG. 1 includes a vehicle data collection apparatus 1 and an abnormality diagnosis apparatus 2.

The vehicle data collection apparatus 1 (hereinafter, referred to as the “collection apparatus 1”) is mounted on each railway vehicle. The railway vehicle used herein refers to a train including one or a plurality of vehicles that are coupled with one another. The collection apparatus 1 collects vehicle data of the railway vehicle on which the collection apparatus 1 is mounted, and transmits the vehicle data to the abnormality diagnosis apparatus 2.

Although one collection apparatus 1 is illustrated in the example of FIG. 1, the abnormality diagnosis system actually includes a plurality of collection apparatuses 1. Therefore, the vehicle data of the respective railway vehicles are transmitted to the abnormality diagnosis apparatus 2 from the respective collection apparatuses 1 mounted on the plurality of railway vehicles. The collection apparatus 1 of FIG. 1 includes a plurality of sensors 11, a data collector 12, and a transmitter 13.

Each of the sensors 11 detects a state of the railway vehicle and outputs a result of the detection. The sensor 11 may detect, as the state of the railway vehicle, a voltage, a current, power, acceleration, speed, a position, and the like of each component (for example, a pantograph) of the railway vehicle, and may detect a control value of each component (for example, a handle of a master controller).

The data collector 12 collects the detection result outputted from each sensor 11. For example, a microcomputer may be used as the data collector 12. The data collector 12 generates the vehicle data that includes the plurality of collected detection results, and provides the generated vehicle data to the transmitter 13.

The transmitter 13 transmits the vehicle data that is provided from the data collector 12 to the abnormality diagnosis apparatus 2 through a wired or wireless communication network. The transmission of the vehicle data may be performed with predetermined time intervals or in response to a predetermined event. Examples of such an event may include arrival of the railway vehicle to a station and entering of the railway vehicle to a predetermined communication area. For example, an existing wireless communication device may be used as the transmitter 13.

The abnormality diagnosis apparatus 2 (hereinafter, referred to as the “diagnosis apparatus 2”) diagnoses abnormality of a regenerative brake of each railway vehicle based on the vehicle data of the plurality of railway vehicles. FIG. 1 is a diagram illustrating a functional configuration of the diagnosis apparatus 2. The diagnosis apparatus 2 of FIG. 1 includes a receiver 21, a vehicle data base (DB) 22, a route DB 23, a diagnostic object setter 24, a diagnosed vehicle data extractor 25, a peripheral vehicle data extractor 26, a reduction amount estimator 27, a regeneration amount corrector 28, and an abnormality diagnoser 29.

The receiver 21 receives the vehicle data of the railway vehicles transmitted from the respective collection apparatuses 1, through a wired or wireless communication network. The receiver 21 inputs the received vehicle data to the vehicle DB 22.

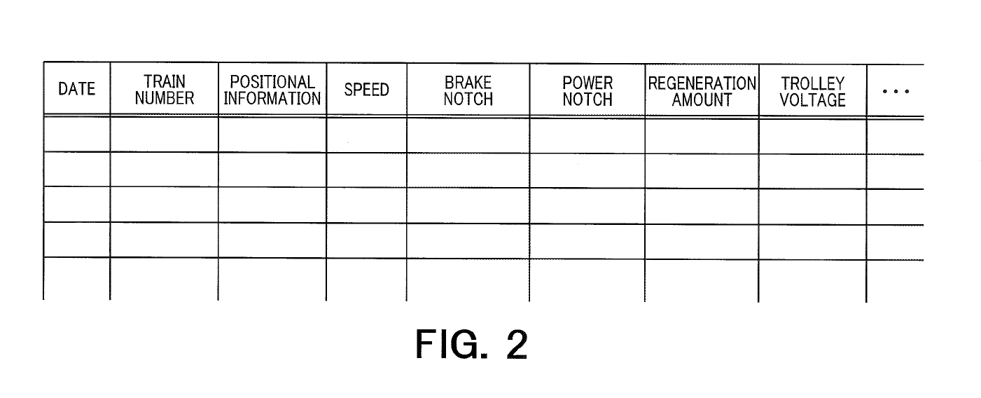

The vehicle DB 22 stores the vehicle data of the plurality of railway vehicles inputted from the receiver 21. FIG. 2 is a diagram illustrating an example of the vehicle DB 22. In FIG. 2, each row corresponds to each vehicle data (each record), and each column corresponds to each field. In the example of FIG. 2, the records include a date, a train number, positional information, speed, a brake notch, a power notch, a regeneration amount, and a trolley voltage.

The date is a detection date by the sensor 11. The train number is a unique identifier (ID) of each railway vehicle. The positional information is information indicating the position of the railway vehicle detected by the sensor 11. The positional information may be represented by a section of the route to which the railway vehicle belongs, may be represented by a distance of the route from a predetermined spot (for example, a station), or may be represented by latitude and longitude. The speed indicates speed of the railway vehicle detected by the sensor 11. The brake notch is a control value of a brake handle detected by the sensor 11. The power notch is a control value of a handle of the master controller detected by the sensor 11. The regeneration amount is an amount corresponding to regenerative power by the regenerative brake provided in the railway vehicle. The regeneration amount may be represented by an optional unit of a current, a voltage, power, force, energy, or the like. The trolley voltage is a voltage of an overhead contact line that feeds power to the railway vehicle, and corresponds to a voltage of the pantograph of the railway vehicle. Note that the vehicle data of FIG. 2 is merely an example, and each vehicle data may include other fields.

The route DB 23 stores route information relating to a route in which the railway vehicle travels. The route information includes a route chart and information relating to facilities (such as a substation) located in the route. The route information is previously stored in the route DB 23 by a user of the diagnosis apparatus 2.

The diagnostic object setter (hereinafter, referred to as the “setter 24”) sets a diagnosis target. The diagnosis target includes a diagnosed vehicle and a diagnosis period. The diagnosed vehicle is a railway vehicle to be diagnosed by the diagnosis apparatus 2. The diagnosis period is a period to be diagnosed by the diagnosis apparatus 2. The diagnosis apparatus 2 diagnoses abnormality of the regenerative brake of the diagnosed vehicle in the diagnosis period. The setter 24 may periodically set a predetermined railway vehicle as a diagnosed vehicle, or may set a railway vehicle inputted by the user of the diagnosis apparatus 2 as a diagnosed vehicle. Also, the setter 24 may periodically set a predetermined period as the diagnosis period, or may set a period inputted by the user of the diagnosis apparatus 2 as the diagnosis period. The setter 24 inputs the set diagnosed vehicle (the train number) and the set diagnosis period to the diagnosed vehicle data extractor 25.

The diagnosed vehicle data extractor 25 (hereinafter, referred to as the “extractor 25”) extracts, from the vehicle DB 22, vehicle data of the diagnosed vehicle in the diagnosis period. More specifically, the extractor 25 extracts the vehicle data of the diagnosed vehicle in a brake operation period of the diagnosed vehicle in the diagnosis period. The brake operation period is a period in which the brake handle of the railway vehicle is operated. The brake operation period corresponds to a period in which the value of the brake notch is not zero.

The extractor 25 provides the extracted vehicle data to the reduction amount estimator 27. The extractor 25 may provide all of the extracted vehicle data to the reduction amount estimator 27 or may provide only data used for calculation of the reduction amount, to the reduction amount estimator 27. Examples of the data used for the calculation of the reduction amount may include the brake notch and the trolley voltage of the diagnosed vehicle.

In addition, the extractor 25 provides the positional information of the diagnosed vehicle to the peripheral vehicle data extractor 26, and provides the regeneration amount of the diagnosed vehicle to the regeneration amount corrector 28.

The peripheral vehicle data extractor 26 (hereinafter, referred to as the “extractor 26”) extracts, from the vehicle DB 22, vehicle data of one or a plurality of peripheral vehicles in the diagnosis period. More specifically, the extractor 26 extracts the vehicle data of the peripheral vehicle in the brake operation period of the diagnosed vehicle in the diagnosis period.

The peripheral vehicle is a railway vehicle different from the diagnosed vehicle. More specifically, the peripheral vehicle is a railway vehicle that travels near the diagnosed vehicle and is fed with power from the same overhead contact line as the overhead contact line that feeds power to the diagnosed vehicle. The same overhead contact line used herein may include overhead contact lines electrically connected through an electric device, a connector, and the like. The railway vehicle that is fed with power from an overhead contact line different from the overhead contact line feeding power to the diagnosed vehicle, is not included in the peripheral vehicle because of not influencing the reduction amount of the diagnosed vehicle.

The peripheral vehicle may be preferably a railway vehicle that travels within a region of a predetermined distance from the diagnosed vehicle. The predetermined distance in this case may be a straight line distance between the railway vehicles, a distance of the overhead contact line between the railway vehicles, or a number of sections between the railway vehicles.

The extractor 26 provides the extracted vehicle data of the respective peripheral vehicles to the reduction amount estimator 27. The extractor 26 may provide all of the extracted vehicle data to the reduction amount estimator 27 or may provide only data used for the calculation of the reduction amount to the reduction amount estimator 27. Examples of the data used for the calculation of the reduction amount may include the brake notch, the power notch, and the trolley voltage of the peripheral vehicle.

The reduction amount estimator 27 (hereinafter, referred to as the “estimator 27”) estimates the reduction amount of the diagnosed vehicle in the brake operation period of the diagnosed vehicle that is included in the diagnosis period, based on the vehicle data of the diagnosed vehicle provided from the extractor 25 and the vehicle data of one or the plurality of peripheral vehicles provided from the extractor 26. The reduction amount is an amount corresponding to variation, by reducing, of the regenerative power of the regenerative brake provided in the railway vehicle. The reduction amount may be represented by an optional unit of a current, a voltage, power, force, energy, or the like. The reduction amount may be calculated by, for example, the following expression.

$$\begin{matrix}[ Expression 1 ] & \\ {R}_{es} = a \times {bn}_{j} + b \times {v}_{j} + {\sum }_{t} f ( {d}_{i} ) \times ( {A}_{i} \times ( {bn}_{i} ) + {B}_{i} \times ( {an}_{i} ) + {C}_{i} \times ( {v}_{i} ) ) & ( 1 )\end{matrix}$$

In the expression 1, “Rₑₛ” is the reduction amount, “bn” is the brake notch, “an” is the power notch, “v” is the trolley voltage, “i” is the train number of the peripheral vehicle, “j” is the train number of the diagnosed vehicle, “d” is a distance between the peripheral vehicle “i” and the diagnosed vehicle, “a”, “b”, “A”, “B”, and “C” are coefficients, and “f” is a function according to the distance. The first term and the second term of the right side in the expression 1 indicate the reduction amount of the diagnosed vehicle caused by the diagnosed vehicle, and the third term indicates the reduction amount of the diagnosed vehicle caused by the peripheral vehicle.

Also, “f” is a function to calculate a weight coefficient of the peripheral vehicle “i” according to the distance “di” between the diagnosed vehicle and the peripheral vehicle “i”. The influence of the peripheral vehicle “i” to the reduction amount “Rₑₛ” depends on the distance “di”. Therefore, weighting according to the distance “di” makes it possible to accurately estimate the reduction amount “Rₑₛ”. Typically, the influence of the peripheral vehicle “i” to the reduction amount “Rₑₛ” is increased as the distance “di” is smaller. In this case, the weight coefficient calculated by the function “f” may be preferably increased as the distance “di” is smaller.

Also, the coefficients “a”, “b”, “A”, “B”, and “C” and the function “f” may be previously set or may be optimized by learning. The estimator 27 applies the vehicle data of the diagnosed vehicle and the peripheral vehicle to the above-described expression, thereby estimating the reduction amount of the diagnosed vehicle.

Note that the method of calculating the reduction amount is not limited to the above-described expression 1. The estimator 27 may use an optional expression allowing the reduction amount to be estimated. The estimator 27 provides the estimated reduction amount of the diagnosed vehicle to the regeneration amount corrector 28.

The regeneration amount corrector 28 (hereinafter, referred to as the “corrector” 28) corrects an regeneration amount “Rₘₑₐₙₛ” of the diagnosed vehicle that is provided from the diagnosed vehicle data extractor 25, based on the reduction amount estimated by the estimator 27. In the following, the regeneration amount corrected by the corrector 28 is referred to as a corrected regeneration amount “R_{cr}”. The corrected regeneration amount “R_{cr}” may be calculated by, for example, the following expression.

R_{cr}=Rₘₑₐₙₛ+k·Rₑₛ [Expression 2]

In the expression 2, “k” is a conversion coefficient to adjust the unit and the level of the regeneration amount “Rₘₑₐₙₛ” and the reduction amount “Rₑₛ”. The conversion coefficient “k” may be previously set or may be optimized by learning. The corrector 28 provides the calculated corrected regeneration amount “R_{cr}” to the abnormality diagnoser 29.

The abnormality diagnoser 29 (hereinafter, referred to as the “diagnoser 29”) diagnoses abnormality of the regenerative brake of the diagnosed vehicle, based on the corrected regeneration amount “R_{cr}” that is provided from the corrector 28, and outputs the diagnosis result. For example, the diagnoser 29 sets one or a plurality of thresholds for the corrected regeneration amount “R_{cr}”, and outputs the diagnosis result according to the relationship between the corrected regeneration amount “R_{cr}” and the threshold.

In the case where one threshold is set, the diagnoser 29 determines that the regenerative brake is “abnormal” when the corrected regeneration amount “R_{cr}” is smaller than the threshold, and determines that the regenerative brake is “normal” when the corrected regeneration amount “R_{cr}” is equal to or larger than the threshold. In the case where two thresholds are set, the diagnoser 29 evaluates the state of the regenerative brake with three stages of “normal”, “abnormality is predicted”, and “abnormal”, according to the relationship between the corrected regeneration amount “R_{cr}” and the thresholds. Note that three or more thresholds may be set.

Also, the diagnoser 29 may calculate an abnormal degree (or a normal degree) based on the corrected regeneration amount “R_{cr}”. In this case, the diagnoser 29 may output the calculated abnormal degree (or the calculated normal degree) as the diagnosis result. Alternatively, the diagnoser 29 may set one or a plurality of threshold for the abnormal degree (or the normal degree) and output a diagnosis result according to the relationship between the abnormal degree (or the normal degree) and the threshold.

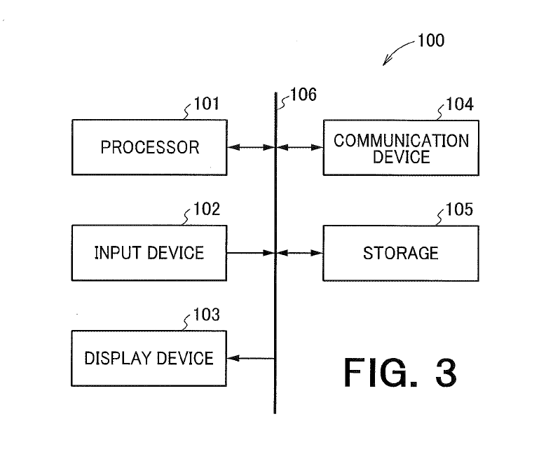

Next, a hardware configuration of the diagnosis apparatus 2 is described with reference to FIG. 3. The diagnosis apparatus 2 according to the present embodiment is configured of a computer 100 that is placed on an operation center of the railway vehicle or the like. The computer 100 includes a server, a client, a microcomputer, a general purpose computer, and the like. The above-described respective functional configurations of the diagnosis apparatus 2 correspond to functions of the computer 100 configuring the diagnosis apparatus 2.

FIG. 3 is a diagram illustrating an example of the computer 100. The computer 100 of FIG. 3 includes a processor 101, an input device 102, a display device 103, a communication device 104, and a storage 105. The processor 101, the input device 102, the display device 103, the communication device 104, and the storage 105 are connected to one another through a bus 106.

The processor 101 is processing circuitry or an electronic circuit including a controller and a calculator of the computer 100. Examples of the processor 101 may include a general purpose processor, a central processing unit (CPU), a microprocessor, a digital signal processor (DSP), a controller, a microcontroller, a state machine, an application specific integrated circuit, a field programmable gate array (FPGA), a programmable logic device (PLD), and any combination thereof.

The processor 101 performs calculation processing based on data and programs that are provided from the devices (for example, the input device 102, the communication device 104, and the storage 105) connected through the bus 106, and outputs the calculation result and control signals to the devices (for example, the display device 103, the communication device 104, and the storage 105) connected through the bus 106. More specifically, the processor 101 executes the operating system (OS) of the computer 100, an abnormality diagnosis program, and the like to control the devices configuring the computer 100.

The abnormality diagnosis program is a program to cause the computer 100 to realize the above-described functional configurations of the diagnosis apparatus 2. The abnormality diagnosis program is stored in a non-temporary tangible computer-readable storage medium. Examples of the above-described storage medium may include an optical disc, a magneto-optical disk, a magnetic disk, a magnetic tape, a flash memory, and a semiconductor memory, without limitation. The processor 101 executes the abnormality diagnosis program, thereby causing the computer 100 to function as the diagnosis apparatus 2.

The input device 102 is a device to input information to the computer 100. Examples of the input device 102 may include a keyboard, a mouse, and a touch panel, without limitation. The user may input the diagnosed vehicle, the diagnosis period, and the like, with use of the input device 102.

The display device 103 is a device to display an image and a picture. Examples of the display device 103 may include a liquid crystal display (LCD), a cathode-ray tube (CRT), and a plasma display (PDP), without limitation. The display device 103 may display the vehicle data stored in the vehicle DB 22, the route information stored in the route DB 23, the diagnosis result outputted from the diagnoser 29, and the like. Also, the above-described diagnostic object setter 24 may be configured of a graphical user interface (GUI) displayed on the display device 103.

The communication device 104 is a device to allow the computer 100 to communicate with an external apparatus (for example, the collection apparatus 1) through a wired or wireless communication. Examples of the communication device 104 may include a modem, a hub, and a router, without limitation. The above-described receiver 21 is configured of the communication device 104.

The storage 105 is a hardware storage or a storage medium that stores the OS of the computer 100, the abnormality diagnosis program, data necessary for execution of the abnormality diagnosis program, data generated by execution of the abnormality diagnosis program, and the like. The storage 105 includes a main storage and an external storage. Examples of the main storage may include a RAM, a DRAM, and an SRAM, without limitation. Examples of the external storage may include a hard disk, an optical disc, a flash memory, and a magnetic tape, without limitation. The vehicle DB 22 and the route DB 23 may be constructed in the storage 105 or in an external server.

Note that the computer 100 may include one or a plurality of processors 101, input devices 102, display devices 103, communication devices 104, and storages 105, respectively, or may be connected with peripherals such as a printer and a scanner.

Also, the diagnosis apparatus 2 may be configured of a single computer 100 or configured as a system including a plurality of computers 100 connected to one another.

Further, the abnormality diagnosis program may be previously stored in the storage 105 of the computer 100, may be stored in an external storage medium of the computer 100, or may be uploaded to the Internet. In any case, the abnormality diagnosis program is installed to the computer 100 and is executed, which realizes the functions of the diagnosis apparatus 2.

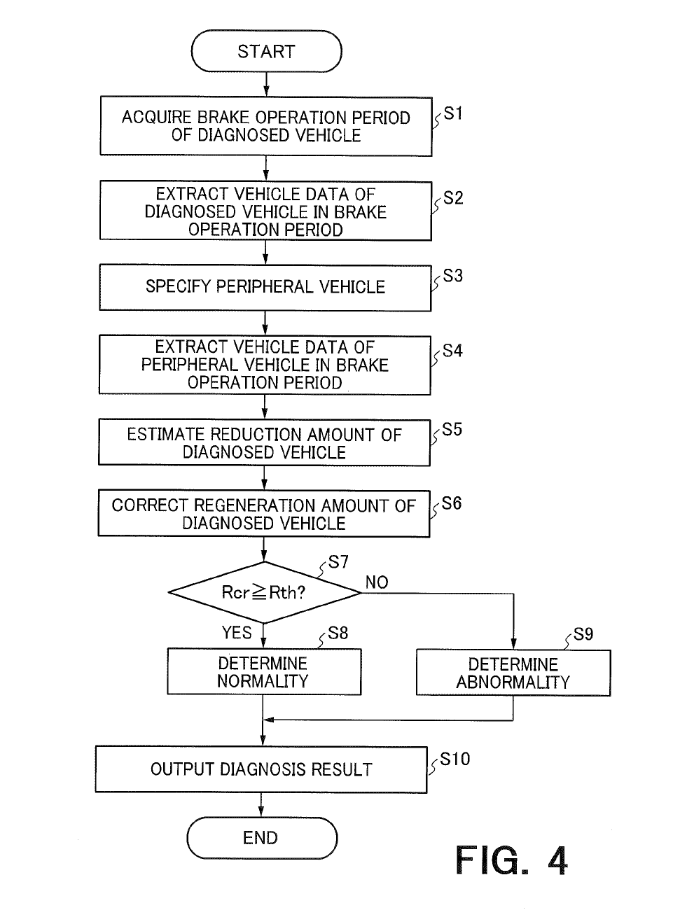

Next, operation of the diagnosis apparatus 2 is specifically described with reference to FIG. 4 to FIG. 6. FIG. 4 is a flowchart illustrating abnormality diagnosis processing by the diagnosis apparatus 2. In the following, it is assumed that the diagnosed vehicle and the diagnosis period have been set.

When the abnormality diagnosis processing is started, the extractor 25 first acquires the brake operation period of the diagnosed vehicle (step S1). More specifically, the extractor 25 acquires a period in which the brake notch is not zero as the brake operation period with reference to the vehicle data, stored in the vehicle DB 22, of the diagnosed vehicle in the diagnosis period.

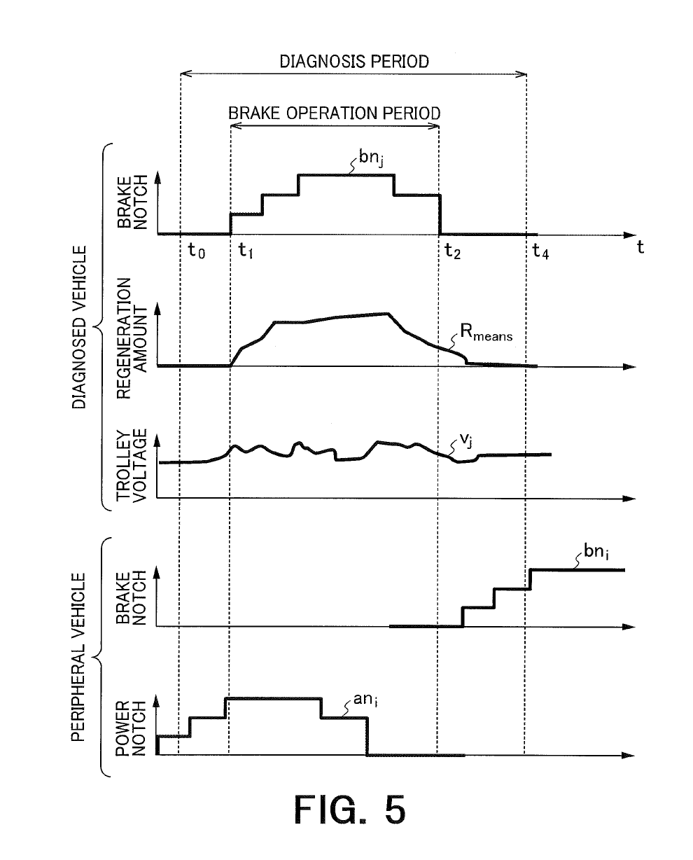

FIG. 5 is a diagram for explaining a method of extracting the vehicle data. In FIG. 5, the diagnosis period is set to a period from t₀ to t₄. In the example of FIG. 5, in the diagnosis period, the period in which the brake notch “bnⱼ” of the diagnosed vehicle is not zero is a period from t₁ to t₂. Thus, the extractor 25 acquires, as the brake operation period, the period from t₁ to t₂.

Thereafter, the extractor 25 extracts, from the vehicle DB 22, the vehicle data of the diagnosed vehicle in the brake operation period (step S2). The vehicle data extracted at this time includes the positional information, the brake notch “bnⱼ”, the regeneration amount “Rₘₑₐₙₛ”, and the trolley voltage “vⱼ”, and the like of the diagnosed vehicle. Note that, as illustrated in FIG. 5, the regenerative brake performs power regeneration during the brake operation period, which increases the regeneration amount “Rₘₑₐₙₛ”.

After extraction of the vehicle data of the diagnosed vehicle, the extractor 25 provides the positional information to the extractor 26, provides the data (such as the brake notch “bnⱼ” and the trolley voltage “vⱼ”) to be used for calculation of the reduction amount “Rₑₛ” to the reduction amount estimator 27, and provides the reduction amount “Rₘₑₐₙₛ” to the regeneration amount corrector 28.

Subsequently, the extractor 26 specifies the peripheral vehicle, based on the positional information of the diagnosed vehicle and the route information (step S3). The extractor 26 first specifies, based on the positional information of the diagnosed vehicle and route information, a range of the route that is fed with power from the overhead contact line same as the overhead contact line that feeds power to the diagnosed vehicle and is included in the region of the predetermined distance from the diagnosed vehicle (hereinafter, referred to as the “peripheral range”).

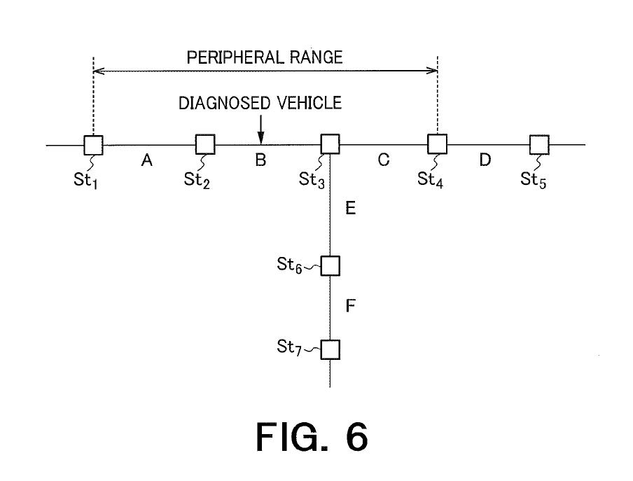

Here, the peripheral range is described with reference to FIG. 6. FIG. 6 is a diagram illustrating an example of the route chart stored in the route DB 23. The route chart of FIG. 6 includes a first route that includes stations St₁ to St₅, and a second route that includes stations St₃, St₆, and St₇. The railway vehicle is fed with power from different overhead contact lines between the first route and the second route. A section between the station St₁ and the station St₂ is referred to as a section A, a section between the station St₂ and the station St₃ is referred to as a section B, a section between the station St₃ and the station St₄ is referred to as a section C, a section between the station St₄ and the station St₅ is referred to as a section D, a section between the station St₅ and the station St₆ is referred to as a section E, and a section between the station St₆ and the station St₇ is referred to as a section F.

Here, a case where the diagnosed vehicle is located in the section B and the peripheral range is within one section from the position of the diagnosed vehicle is assumed. In this case, the peripheral range is within one section from the section B, and is a section within which power is fed from the same overhead contact line as the overhead contact line that feeds power within the section B. Therefore, the extractor 26 specifies the sections A, B, and C, as the peripheral range. The section E is not included in the peripheral range because of being fed with power from an overhead contact line different from the overhead contact line that feeds power within the section B. In this way, the extractor 26 specifies the peripheral range, based on the route information (the route chart) and the positional information of the diagnosed vehicle.

Next, the extractor 26 refers to the positional information of the respective railway vehicles stored in the vehicle DB 22, searches the railway vehicle that was traveling the above-described peripheral range during the brake operation period, and specifies, as the peripheral vehicle, the railway vehicle other than the diagnosed vehicle, out of the found railway vehicles.

Subsequently, the extractor 26 extracts, from the vehicle DB 22, the vehicle data of the specified peripheral vehicle in the brake operation period (step S4). In the example of FIG. 5, the brake notch “bnⱼ” and the power notch “anᵢ” of the peripheral vehicle in the brake operation period are illustrated; however, the vehicle data of the peripheral vehicle to be extracted may include the trolley voltage “vⱼ”. In addition, the extractor 26 may extract the positional information of the diagnosed vehicle, and calculate the distance “dᵢ” between the diagnosed vehicle and the peripheral vehicle in the brake operation period, and the distance “dᵢ” may be included in the vehicle data.

After the extraction of the vehicle data of the peripheral vehicle, the extractor 26 provides the extracted vehicle data of each peripheral vehicle to the estimator 27.

The estimator 27 that has been provided with the vehicle data of the diagnosed vehicle and the peripheral vehicle in the brake operation period estimates the reduction amount “Rₑₛ” of the diagnosed vehicle in the brake operation period, based on the provided vehicle data (step S5). The reduction amount “Rₑₛ” may be calculated by, for example, the expression 1. The estimator 27 provides the estimated reduction amount “Rₑₛ” to the corrector 28.

The corrector 28 that has been provided with the reduction amount “Rₑₛ” of the diagnosed vehicle in the brake operation period corrects the regeneration amount “Rₘₑₐₙₛ” of the diagnosed vehicle provided from the extractor 25, based on the reduction amount “Rₑₛ” (step S6). The corrected regeneration amount “R_{cr}” may be calculated by, for example, the expression 2. The corrector 28 provides the calculated corrected regeneration amount “R_{cr}” to the diagnoser 29.

The diagnoser 29 that has been provided with the corrected regeneration amount “R_{cr}” compares the corrected regeneration amount “R_{cr}” with a threshold “Rₜₕ” of the regeneration amount (step S7). When the corrected regeneration amount “R_{cr}” is equal to or higher than the threshold “Rₜₕ” (Yes in step S7), the diagnoser 29 determines that the regenerative brake of the diagnosed vehicle is normal (step S8). On the other hand, when the corrected regeneration amount “R_{cr}” is lower than the threshold “Rₜₕ” (No in step S7), the diagnoser 29 determines that the regenerative brake of the diagnosed vehicle is abnormal (step S9). Note that the diagnosis method by the diagnoser 29 is not limited thereto, as mentioned above.

Thereafter, the diagnoser 29 outputs the diagnosis result (step S10). The outputted diagnosis result may be displayed on, for example, the display device 103. As a result, the user of the diagnosis apparatus 2 can comprehend the diagnosis result, and utilize the diagnosis result for maintenance and management of the diagnosed vehicle. Note that the diagnosis result may be stored in the storage 105 or may be transmitted to an external apparatus by the communication device 104.

As mentioned above, the diagnosis apparatus 2 according to the present embodiment estimates the reduction amount “Rₑₛ” of the diagnosed vehicle, based on the vehicle data of the diagnosed vehicle and the vehicle data of the peripheral vehicle, and corrects the regeneration amount “Rₘₑₐₙₛ” of the diagnosed vehicle with use of the estimated reduction amount “Rₑₛ”. As a result, this makes it possible for the diagnosis apparatus 2 to remove influence of the other railway vehicles from the regeneration amount “Rₘₑₐₙₛ” that is an actual measured value of the regeneration amount of the diagnosed vehicle. Since the diagnosis apparatus 2 diagnoses abnormality of the regenerative brake of the diagnosed vehicle, based on the corrected regeneration amount “R_{cr}” obtained in this way, it is possible to diagnose the abnormality of the regenerative brake with high accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An abnormality diagnosis apparatus, comprising:
processing circuitry configured to
estimate a reduction amount of a regeneration amount of a diagnosed vehicle that is a railway vehicle, based on vehicle data of the diagnosed vehicle and vehicle data of a peripheral vehicle different from the diagnosed vehicle;
correct the regeneration amount of the diagnosed vehicle, based on the estimated reduction amount; and
diagnose abnormality of a regenerative brake of the diagnosed vehicle, based on the corrected regeneration amount.

2. The abnormality diagnosis apparatus according to claim 1, wherein the peripheral vehicle is a railway vehicle which is fed with power from same contact line as a contact line feeding power to the diagnosed vehicle.

3. The abnormality diagnosis apparatus according to claim 1, wherein the peripheral vehicle is a railway vehicle which travels within a region of a predetermined distance from the diagnosed vehicle.

4. The abnormality diagnosis apparatus according to claim 1, wherein the vehicle data includes one or more of a brake notch, a regeneration amount, a trolley voltage, a power notch, and positional information.

5. The abnormality diagnosis apparatus according to claim 1, wherein the processing circuitry determines that the regenerative brake is abnormal when the corrected regeneration amount is smaller than a predetermined threshold.

6. The abnormality diagnosis apparatus according to claim 1, wherein the processing circuitry estimates the reduction amount, based on the vehicle data of the diagnosed vehicle and the peripheral vehicle in a brake operation period of the diagnosed vehicle.

7. The abnormality diagnosis apparatus according to claim 1, wherein the processing circuitry calculates a sum of the reduction amount estimated by the estimator and the regeneration amount in a brake operation period of the diagnosed vehicle.

8. The abnormality diagnosis apparatus according to claim 1, further comprising a vehicle database configured to store vehicle data of a plurality of railway vehicles, which include the diagnosed vehicle and the peripheral vehicle.

9. The abnormality diagnosis apparatus according to claim 8, wherein the processing circuitry extracts the vehicle data of the diagnosed vehicle from the vehicle data that is stored in the vehicle database.

10. The abnormality diagnosis apparatus according to claim 8, wherein the processing circuitry extracts the vehicle data of the peripheral vehicle from the vehicle data that is stored in the vehicle database.

11. The abnormality diagnosis apparatus according to claim 1, further comprising a route database configured to store route information relating to a route on which the railway vehicle travels.

12. An abnormality diagnosis method, comprising:
estimating a reduction amount of a regeneration amount of a diagnosed vehicle that is a railway vehicle, based on vehicle data of the diagnosed vehicle and vehicle data of a peripheral vehicle different from the diagnosed vehicle;
correcting the regeneration amount of the diagnosed vehicle, based on the estimated reduction amount; and
diagnosing abnormality of a regenerative brake of the diagnosed vehicle, based on the corrected regeneration amount.

13. A non-transitory computer readable medium having a computer program stored therein which when executed by a computer, causes the computer to perform processing of steps comprising:
estimating a reduction amount of a regeneration amount of a diagnosed vehicle that is a railway vehicle, based on vehicle data of the diagnosed vehicle and vehicle data of a peripheral vehicle different from the diagnosed vehicle;
correcting the regeneration amount of the diagnosed vehicle, based on the estimated reduction amount; and
diagnosing abnormality of a regenerative brake of the diagnosed vehicle, based on the corrected regeneration amount.
